(19) United States
(12) Patent Application Publication
(10) Pub. No.: US 2004/0122591 A1
(43) Pub. Date: Jun. 24, 2004

(54) Method of initializing a navigation system

(76) Inventor: Philip MacPhail, Cambridge (GB)

Correspondence Address: KENYON & KENYON, 1500 K STREET, N.W., SUITE 700, WASHINGTON, DC, 20005, US

(21) Appl. No.: 10/321,642

(22) Filed: Dec. 18, 2002

(51) Int. Cl. G01C 21/34

(52) U.S. Cl. 701/209; 701/211

(57) ABSTRACT

A variety of methods of orienting a user of a personal navigation device are described. The user of personal navigation device activates a navigation service and specifies a desired destination. A processor determines a route between the current location of the user and the desired destination. Techniques discussed for orienting the user utilize visible landmarks, dead reckoning, compass information or a combination of these techniques. Once the orientation of the user is established the user is instructed to proceed along the route.

### FIELD OF THE INVENTION

The invention relates to navigation systems and, more specifically, to portable navigation systems which receive data from a remote database.

### BACKGROUND OF THE INVENTION

Navigation systems are now widely available for a variety of different luxury automobiles. These navigation systems rely on global positioning system (GPS) data, extensive navigation databases, and other sensor data. One key advantage allowing for simplifying the implementation of a navigation system for an automobile is that the vehicle is generally assumed to be traveling forward. As such, the navigation system incorporates sensors that determine the direction that the car is facing. Typically, the navigation system will incorporate a compass however other options exist for determining orientation. Thus, the navigation system merely needs to inform the driver of the automobile when to turn left or right.

Recent developments have provided more affordable GPS devices that provide a navigation system for an individual. In U.S. Pat. No. 6,124,826, Garthwaite et al. describe a portable communications device that establishes a wireless communication link with a remote navigation computer. In a proposed embodiment, the portable communications device is a cellular telephone with an integrated GPS. The user specifies a desired destination using the cellular telephone. This information as well as the current GPS position of the cellular telephone is provided to a remote navigation computer. The navigation computer compares the current GPS position with the desired destination and establishes a route consistent with a navigation database. Unfortunately, it is assumed that the user is already traveling toward their destination. Clearly, once the user is moving along the correct route, the orientation of the user is known. Unfortunately, it is unlikely that users who are in the right place and moving in the right direction will be seeking navigational assistance. It is more likely that a lost individual will seek assistance. Further unfortunately, the prior art system cannot help such a lost individual as they stand seeking assistance; the cellular telephone and the individual are in an unknown orientation both to the navigation system and to each other. Alternatively, an individual will be diverted as they follow a navigation path. For example, a tourist receiving instructions to go to a specified destination may take a detour from the programmed path to, for example, take some photographs. When the person stops moving it is now longer practical to assume that they are facing in any particular direction.

While a variety of modifications are possible to determine the orientation of the cellular telephone these design modification are not always helpful. The cellular telephone could be worn on a belt (hands free) or held up to either ear. As such, knowing the orientation of the cellular telephone is not helpful.

It would be advantageous to have personal navigation devices that provide a user with clear navigation instructions that permit the orientation of the user of the cellular telephone to be determined in advance of providing navigation instructions associated with a predetermined navigation path.

### SUMMARY OF THE INVENTION

In accordance with the invention there is provided a method of providing directional information, comprising the steps of: sensing location information with a position sensor within a cellular telephone; providing the location information from the cellular telephone to a processor; providing a destination to the processor; performing one of orienting the individual in a known predetermined orientation and determining an orientation of the individual relative to stored geographic data stored in memory accessible by the processor; determining a route between the position and the destination; determining a set of directional instructions consistent with the position, the route, and the orientation of the individual; and, providing an appropriate instruction from the set of directional instructions to the individual.

### BRIEF DESCRIPTION OF THE DRAWINGS

The invention will now be described with reference to the drawings in which:

FIG. 1 is a schematic diagram of a navigation system;

FIG. 2 is a flowchart according to the invention in which a cellular telephone user is instructed to move in order to determine their orientation;

FIG. 3 is a flowchart according to the invention in which a cellular telephone user is instructed to orient themselves relative to a landmark;

FIG. 4a is a simplified block diagram of a cellular telephone incorporating a compass therein for use with the methods of FIGS. 4b and 5;

FIG. 4b is a flowchart according to the invention in which a cellular telephone user provides compass data to a navigation system;

FIG. 5 is a flowchart according to the invention in which a user orients themselves relative to compass data; and,

FIG. 6 is a flowchart according to an embodiment of the invention in which a set of waypoints is provided to a personal navigation device.

### DETAILED DESCRIPTION OF THE INVENTION

A variety of techniques are available for orienting a user of a portable navigation device. For example, in U.S. Pat. No. 6,029,069 Takaki discloses a person navigation system in which a user is questioned by an automated system and instructions are provided in dependence upon the response of the user. This system relies on the user recognizing landmarks or being able to specify specific buildings. While this may be useful in navigating within, for example, a university environment where the buildings are easily distinguished, it is less useful to an individual who is not familiar with the area being navigated. Clearly, looking for specific landmarks while one is in a hurry is a distraction. Additionally, in congested cities where navigation is often complicated it is frequently difficult to perceive the landmarks that such a system will request. Further, it is often necessary for the user to specify a large number of landmarks in order for the system to properly recognize his position and orientation.

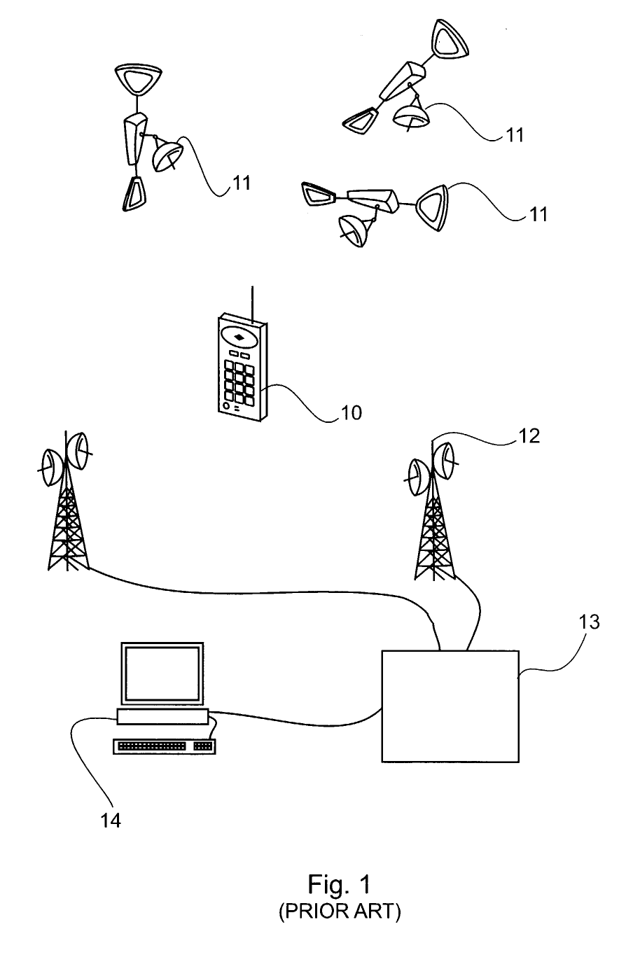

Referring to FIG. 1, a schematic diagram is shown for a prior art navigation system consistent with an embodiment of U.S. Pat. No. 6,124,826 by Garthwaite et al. The navigation system includes: a cellular telephone 10 with GPS, GPS satellites 11, a wireless transmission tower 12, a base unit 13 and a navigation computer 14 having an extensive navigation database. In operation, a user of the cellular telephone 10 calls a navigation service. Thus, a communications path is established between the cellular telephone 10 and the navigation computer 14 using the conventional cellular telephone network. The cellular telephone 10 receives GPS signal data from the GPS satellites 11 and is able to establish the location of the cellular telephone 10 based upon the GPS signal data. The location of the cellular telephone 10 is sent to the navigation computer 14 as well as desired destination information. This allows the navigation computer to determine a route. The prior art provides voice instructions to the user regarding where to turn and how far to go. A voice synthesis program and navigation databases are stored remotely and updated as necessary. Unfortunately, the method taught only applies to users already moving along the indicated path.

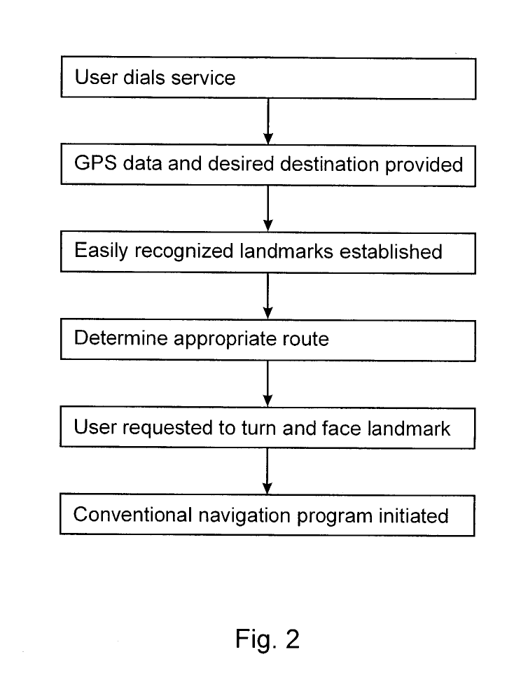

Referring to FIG. 2, a flowchart descriptive of the use of the navigation system of FIG. 1 according to an embodiment of the invention is provided. In operation, a user contacts a navigation service from a cellular telephone. The navigation service receives a signal from the cellular telephone indicating the desired destination. A second signal is provided from the cellular telephone to the navigation service indicating the current location of the cellular telephone based upon the GPS data. The navigation service includes a computer for comparing the GPS data with data within a navigation database. The computer then determines a set of simple easily recognizable landmarks within view of the user's location as indicated by the GPS data and based upon information from the navigation database. Additionally, the computer determines an appropriate route for the user towards the desired destination. For example, if the GPS data indicates that the user is on a walkway of the Sydney harbor then the navigation system indicates that the user should walk along a walkway towards the Sydney opera house. Alternatively, if the desired destination was in an opposite direction then the system transmits a signal indicative of the user walking along the walkway away from the Sydney opera house. Clearly, a wide variety of landmarks are possible so long as they are stored within the navigation database. Optionally, since the GPS information is available, the navigation system has access to the local time where the user is located. When the navigation system is coupled to meteorological and/or astronomical databases it has access to solar position data or lunar position data as “landmarks,” weather conditions permitting.

Of course, when landmarks are not in the direction of travel of the individual, the system orients the individual relative to the landmark—for example by requesting that the individual faces a landmark—and then reorients the individual—for example by directing the individual to turn right.

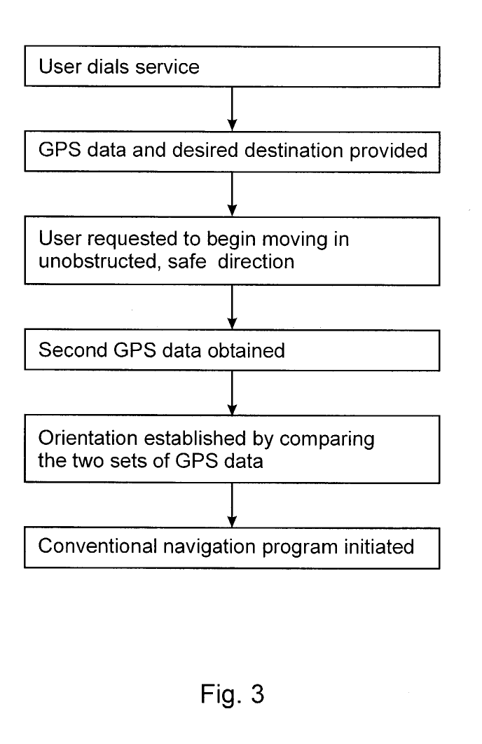

Referring to FIG. 3, a flowchart according to a second embodiment of the invention is provided. In operation, a user dials a navigation service from the cellular telephone. The navigation service receives a signal from the cellular telephone indicating the desired destination. A second signal is provided to the navigation system from the cellular telephone indicating the current location of the cellular telephone based upon the GPS data. The navigation system transmits to the cellular telephone a signal requesting that the user of the cellular telephone move forward in an approximately straight line in a safe direction. The navigation computer continues receiving GPS data from the cellular telephone. When the user has moved to displace the cellular telephone sufficiently that a new, substantially different, GPS location is indicated (approximately 3 meters), an orientation of the individual is computed based on the GPS data by calculating a vector between the two points. Once the location and orientation of the user are known a route is generated to lead the user to the desired destination and, based on the user's known orientation, instructions are provided to the user.

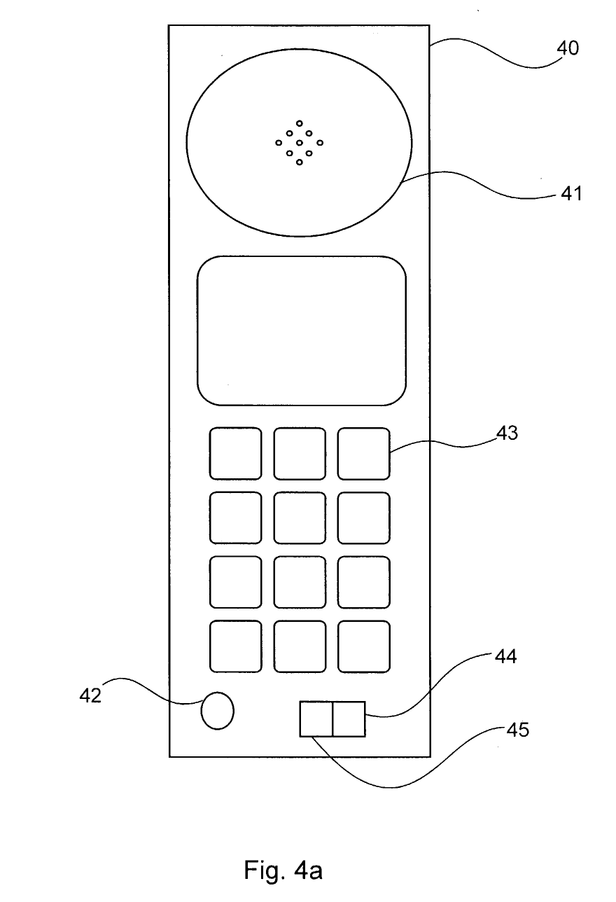

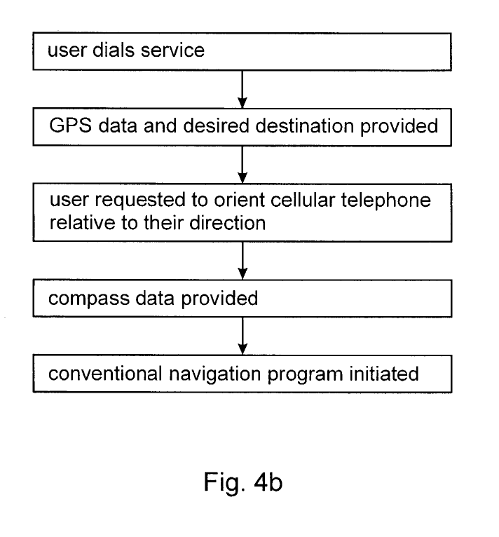

Referring to FIG. 4a, an embodiment of an apparatus according to the invention is shown. A cellular telephone 40 is shown having a microphone 41, a speaker 42, a keypad 43, a GPS receiver 44, and a compass 45. The device, by integrating a compass with the cellular telephone and GPS provides for functionality supporting further embodiments of the inventive method.

Referring to FIG. 4b, a flowchart descriptive of an alternative embodiment of the invention is provided. In operation, a user contacts a navigation service from the cellular telephone. The navigation service receives a signal from the cellular telephone indicating the desired destination. A second signal is provided from the cellular telephone to the navigation service indicating the current location of the cellular telephone based upon the GPS data. An instruction is provided from the navigation service to the cellular telephone and intended for the user requesting that the cellular telephone be oriented in a predetermined fashion relative to the user. In an exemplary instruction, the user is asked to point the speaker of the cellular telephone up with the antenna straight ahead of the user, and then to press the “1” key. Compass data is provided from the compass integrated within the cellular telephone and a third signal is provided from the cellular telephone to the navigation service including the compass data. Once the compass data is received by the navigation computer, the user orientation is known due to the known orientation of the cellular telephone relative to the compass and relative to the user. A route to the desired destination is determined and instructions are forwarded to the user via the cellular telephone from the navigation service.

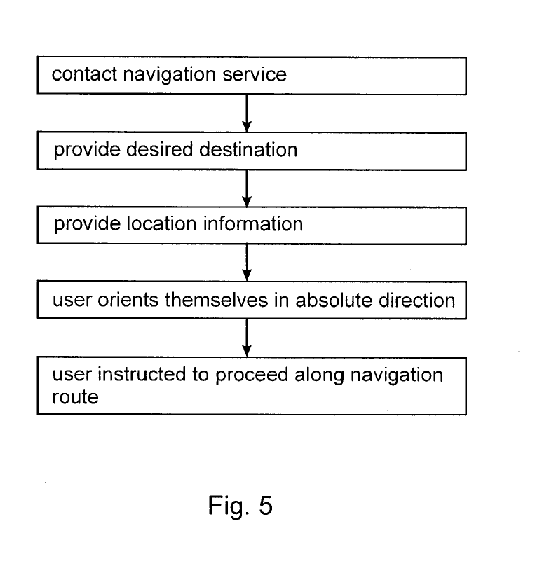

Referring to FIG. 5, a flowchart descriptive of an alternative embodiment of the invention is provided. In operation, a user contacts a navigation service from the cellular telephone. The navigation service receives a signal from the cellular telephone indicating the desired destination. A second signal is provided from the cellular telephone to the navigation service indicating the current location of the cellular telephone based upon the GPS data. An instruction is provided from the navigation service to the user to orient themselves in a predetermined absolute direction. The user holds the cellular telephone of FIG. 4a in front of them and rotates until the direction indicated on the cellular telephone is the predetermined direction. Alternatively, the phone shows an actual compass pointing north and the user rotates themselves relative to north. Now, the user orientation is known. A route to the desired destination is determined and instructions are forwarded to the user via the cellular telephone from the navigation service.

The embodiments of the invention provided herein are intended to illustrative of the invention, however, numerous other embodiments of the invention may be envisioned by a person of skill in the art without departing from the spirit and the scope of the invention.

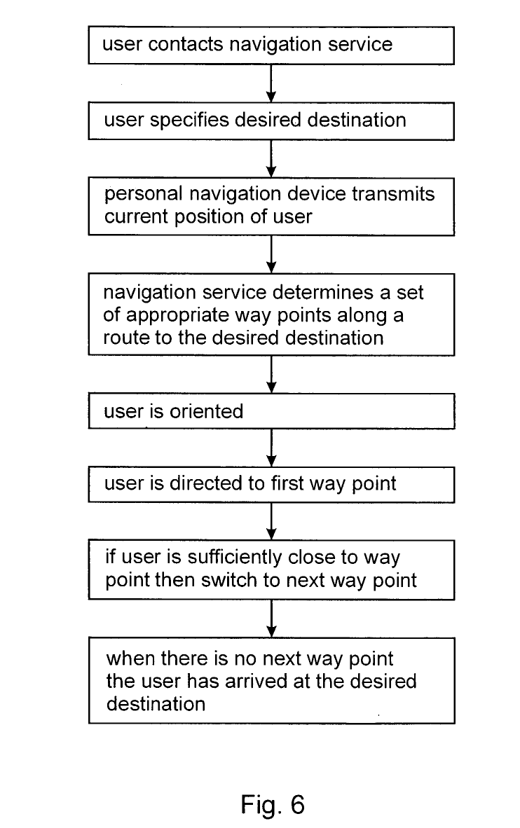

Referring to FIG. 6, a flowchart consistent with an embodiment of the invention is shown. In this embodiment of the invention, a personal navigation device comprising a cellular telephone having a processor, a GPS and a compass is used to direct a user to a desired destination. A user establishes a wireless communication data link with a navigation service and specifies a desired destination. The personal navigation device also transmits data consistent with the current location of the user. The navigation service consults a geographic database and determines an appropriate set of waypoints, the last of which is the desired destination. Position information associated with the waypoints is provided to the personal navigation device. The orientation of the user of the personal navigation device is established by orienting the user relative to a visible landmark. The user is then directed to proceed to the first waypoint. The personal navigation device includes a directional feedback system that provides data to the user of whether the next waypoint is to the left or right of the current orientation of the user. When the user is sufficiently proximate a waypoint, the user is directed to the next waypoint.

Since the personal navigation device stores all of the necessary waypoints, it is unnecessary to maintain continuous contact with a remote navigation computer. Additionally, in many circumstances, a user traveling on foot will not follow the predetermined navigation route. For example, a user with such a personal navigation system might have to meet a friend at a specific time and location. While going to meet the friend, the user sees, for example, a statue in a park. The user walks around the statue, a movement inconsistent with the route stored by the personal navigation device. Clearly, in this case, providing audio cues to the user that they have deviated from a desired path is an annoyance. The user is likely aware that the path to the desired destination does not include circling a statue. Although the user wishes to arrive at the destination, the user may also wish to interact with their environment. Additionally, a user on foot has many different options for going between points. While a traditional automotive navigation system would only suggest routes that follow roads, a person on foot may chose not to follow roads and sidewalks. For example, a user of a personal navigation system might choose to walk though a park instead of following a suggested route along a street. As long as the user does not deviate too much from the desired route the user will be able to head toward the next waypoint. If the user has deviated substantially from the path between waypoints then the user is free to establish a new path by redialing the navigation service and making another request for a route to the desired destination.

Clearly, a variety of methods exist for establishing the orientation of the user as described herein above. Additionally, in the event that one of these methods is inadequate another method is optionally chosen.

In an alternative embodiment of the invention the personal navigation device includes an input for receiving geographic data and a memory for storing the geographic data. This permits the device to produce routes within an area corresponding to the provided geographic data. Thus, the user is more autonomous and does not rely on cellular telephone systems for navigation solutions within that area. Clearly, such a system is still able to take advantage of the methods or orienting the user as described herein above. Additionally, when a user deviates from a predetermined path, a new path is easily generated based upon the current location of the user and the desired destination.

The invention also provides a simple method of orienting an individual. In this case, a cellular telephone has a GPS receiver and a display. In use, the user moves from a first position to a second position. The change in position is used to determine the direction that the user is facing. The direction is then provided on the display. Clearly, this method is useable for determining the orientation of the user relative to any fixed geographic position and is not limited to, for example, providing the orientation of the user relative to the north pole.

Numerous other embodiments of the invention will be envisaged by a person of skill in the art without departing from the spirit and scope of the invention.

What is claimed is:

1. A method of providing directional information to an individual, comprising the steps of:
determining location information with a position sensor disposed within a cellular telephone;
providing the location information from the cellular telephone to a processor;
providing a destination to the processor;
orienting the individual in a known predetermined orientation;
determining a route between the position and the destination;
determining a set of directional instructions consistent with the position, the route and the orientation of the individual; and,
providing an appropriate instruction from the set of directional instructions to the individual.

2. A method of providing directional information according to claim 1, wherein the processor is disposed remote to the cellular telephone.

3. A method of providing directional information according to claim 2, wherein the processor and the cellular telephone communicate via a wireless communication medium.

4. A method of providing directional information according to claim 1, wherein the step of orienting the individual comprises the step of:
orienting the individual relative to a known landmark.

5. A method of providing directional information according to claim 4 wherein the step of orienting the individual comprises the steps of:
determining a landmark from a set of geographic data, the landmark potentially visible from a first position; and,
instructing the individual to orient themselves relative to the determined landmark.

6. A method of providing directional information according to claim 1, wherein the step of orienting the individual comprises the step of:
orienting the individual using a compass integral within the cellular telephone.

7. A method of providing directional information according to claim 6, wherein the step of orienting the individual comprises the step of:
providing to the individual a known orientation for use by the individual in orienting the individual using a compass integral within the cellular telephone.

8. A method of providing directional information to an individual, comprising the steps of:
determining location information with a position sensor disposed within a cellular telephone;
providing the location information from the cellular telephone to a processor;
providing a destination to the processor;
determining an orientation of the individual relative to geographic data stored within memory accessible by the processor;
determining a route between the location information and the destination;
determining a set of directional instructions consistent with the location information, the route and the orientation of the individual; and,
providing an appropriate instruction from the set of directional instructions to the individual.

9. A method of providing directional information according to claim 8, wherein the processor is disposed remote to the cellular telephone.

10. A method of providing directional information according to claim 8, wherein the processor and the cellular telephone communicate via a wireless communication medium.

11. A method of providing directional information according to claim 8, wherein the step of determining an orientation of the individual relative to stored geographic data comprises the steps of:
providing position data relating to a position of the individual, the position different from the location information;
determining an orientation of the individual by assuming the individual is traveling in a straight line between the location information and the position.

12. A method of providing directional information according to claim 11 comprising the step of:
prompting the individual to walk in a straight line.

13. A method of providing directional information according to claim 8, wherein the step of determining an orientation of the individual relative to stored geographic data comprises the steps of:
holding the cellular telephone in predetermined orientation relative to the individual; providing a signal from a compass integral with the cellular phone to the processor; and, determining an orientation of the individual in dependence upon the provided signal.

14. A method of orienting an individual, the method comprising:
determining location information with a position sensor disposed within a cellular telephone;
providing the location information from the cellular telephone to a processor;
providing position data relating to a position of the individual to the processor, the position different from the location;
determining an orientation of the individual by assuming the individual is traveling in a straight line between the location and the position.
